(19) United States
(12) Patent Application Publication
(10) Pub. No.: US 2026/0170503 A1
(43) Pub. Date: Jun. 18, 2026

(54) METHOD FOR DETECTING FRAUDULENT USERS IN A MARKETPLACE SYSTEM

(71) Applicant: Grabtaxi Holdings Pte. Ltd., Singapore (SG)

(72) Inventors: Min CHEN, Singapore (SG); Advitiya VASHIST, Singapore (SG); Xue Fang NG, Singapore (SG); Jia CHEN, Singapore (SG)

(21) Appl. No.: 19/124,903

(22) PCT Filed: Sep. 29, 2023
(86) PCT No.: PCT/SG2023/050655

§ 371 Date: Apr. 28, 2025

(30) Foreign Application Priority Data
Nov. 1, 2022 (SG) 10202251568V

(51) Int. Cl. G06Q 20/40

(52) U.S. Cl. CPC G06Q 20/4016

(57) ABSTRACT

Aspects concern a method for detecting fraudulent users in a marketplace system, comprising generating a graph, wherein users are represented as nodes of the graph and two nodes are connected by an edge if the user represented by one of the nodes has used at least one marketplace system element which was also used by the user represented by the other of the nodes in the marketplace system and each node is associated with a feature set including information about behaviour of the user who is represented by the node in the marketplace system and structure information about a subgraph of the graph to which the node belongs, processing the graph by a graph convolutional neural network configured to generate a score for each node of the graph and detecting one or more fraudulent users using the scores.

### TECHNICAL FIELD

Various aspects of this disclosure relate to methods for detecting fraudulent users in a marketplace system.

### BACKGROUND

Detecting fraud in online to offline (O2O) marketplaces has become more and more important due to the increasing popularity of this type of services around the world, e.g., ride hailing, food delivery, etc. Unlike e-commerce or social media platforms that only use online channels, O2O business uses both online and offline channels to acquire users and perform transactions, e.g., a user ordering food online needs an offline driver to deliver the food to the user's location.

Detecting fraud in O2O marketplaces is challenging because there are many different types of fraudulent activities in an O2O marketplace. For example, some fraudsters create many fake accounts to abuse a promotion code, while some fraudsters take advantage of an offline channel, e.g., colluding with merchants or drivers to perform fraudulent transactions, which are notably different from the fraud activities in online services such as e-commerce services.

Accordingly, efficient approaches for detecting fraud in an O2O marketplace are desirable.

### SUMMARY

Various embodiments concern a method for detecting fraudulent users in a marketplace system, comprising generating a graph, wherein users are represented as nodes of the graph and two nodes are connected by an edge if the user represented by one of the nodes has used at least one marketplace system element which was also used by the user represented by the other of the nodes in the marketplace system and each node is associated with a feature set including information about behaviour of the user who is represented by the node in the marketplace system and structure information about a subgraph of the graph to which the node belongs, processing the graph by a graph convolutional neural network configured to generate a score for each node of the graph and detecting one or more fraudulent users using the scores.

According to one embodiment, the structure information about the subgraph of the graph to which the node belongs includes information about how the node is connected to other nodes of the graph.

According to one embodiment, wherein the structure information about the subgraph of the graph to which the node belongs includes at least one of the quantity (i.e. the number) of other nodes connected to the node, information on how densely the node is connected to other nodes and the quantity (i.e. the number) of nodes of the subgraph, wherein the subgraph is the largest connected subgraph of the graph to which the node belongs.

According to one embodiment, the information about the behaviour of the user includes information indicative of the integrity of the user.

According to one embodiment, the marketplace system is an online to offline marketplace system.

According to one embodiment, the marketplace system element is an online channel or an offline channel of the online to offline marketplace system.

According to one embodiment, the marketplace system element is a user device, an Internet protocol address, a merchant, a driver or a vehicle.

According to one embodiment, the graph convolutional neural network is configured to generate an embedding of each node and is configured to generate, for each node, the score for the node from the embedding of the node.

According to one embodiment, the information about the behaviour of the user includes one or more of an age of an account the user has with the marketplace system, a number of orders issued by the user in the marketplace system, a ratio of promotion orders among the orders issued by the user in the marketplace system, an average order value of the user in the marketplace system, a time since the last login by the user in the marketplace system, a time since the last order by the user in the marketplace system, a total profit of the user in the marketplace system.

According to one embodiment, the method comprises detecting one or more fraudulent users using the scores by detecting a user as being a fraudulent user if the score of the node lies within a predetermined range.

According to one embodiment, the method comprises training the graph convolutional neural network by semi-supervised training using a labelled training data set comprising labels indicating fraudulent users. The training is done before using the graph convolutional neural network for detecting fraudulent users.

According to one embodiment, the method comprises activating a security measure for a user if the user was detected as fraudulent user.

According to one embodiment, a computer program element is provided comprising program instructions, which, when executed by one or more processors, cause the one or more processors to perform the method for detecting fraudulent users in a marketplace system described above.

According to one embodiment, a computer-readable medium is provided comprising program instructions, which, when executed by one or more processors, cause the one or more processors to perform the method for detecting fraudulent users in a marketplace system described above.

### BRIEF DESCRIPTION OF THE DRAWINGS

The invention will be better understood with reference to the detailed description when considered in conjunction with the non-limiting examples and the accompanying drawings, in which:

FIG. 1 shows a communication arrangement including a smartphone and a server.

FIG. 2 shows a diagram illustrating a data processing flow for fraud detection according to an embodiment, e.g. performed by the server.

FIG. 3 shows an example for an O2O graph.

FIG. 4 illustrates the processing of an input graph by the machine learning model.

FIG. 5 shows a flow diagram illustrating a method for detecting fraudulent users in a marketplace system.

FIG. 6 shows a server computer system according to an embodiment.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the devices or methods are analogously valid for the other devices or methods. Similarly, embodiments described in the context of a device are analogously valid for a vehicle or a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

In the following, embodiments will be described in detail.

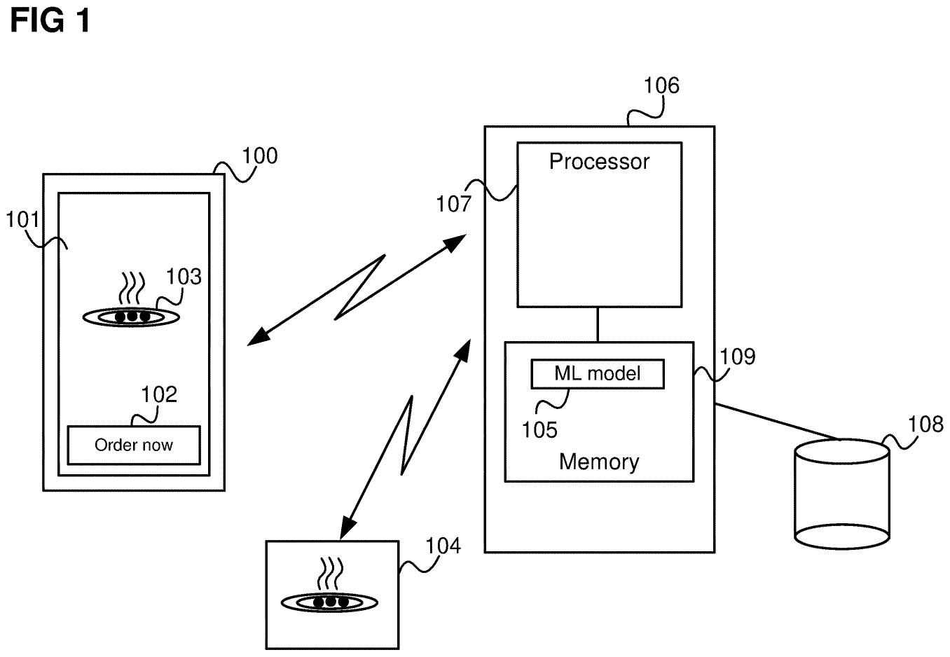

FIG. 1 shows a communication arrangement including a smartphone 100 and a server (computer) 106.

The smartphone 100 has a screen showing the graphical user interface (GUI) of an app for using one or more of various services, such as ordering food or e-hailing, which the smartphone's user has previously installed on his smartphone and has opened (i.e. started) to use the service, e.g. to order food.

The GUI 101 includes graphical user interface elements 102, 103 helping the user to use the service, e.g. a map of a vicinity of the user's position, food available in the user's vicinity (which the app may determine based on a location service, e.g. a GPS-based location service), a button for placing an order, etc.

When the user has made a selection for a service, e.g. a selection of a restaurant or an online supermarket and/or a selection of food or groceries to order, the app communicates with a server 106 of the respective service via a radio connection. The server 106 (carrying out a corresponding server program by means of a processor 107) may consult a memory 109 or a data storage 108 having information regarding the service (e.g. prices, availability, estimated time for delivery etc.) The server communicates any data relevant or requested by the user (such as estimated time for delivery) back to the smartphone 100 and the smartphone 100 displays this information on the GUI 101. The user may finally accept a service, e.g. order food. In that case, the server 106 informs the service provider 104, e.g. a restaurant or online supermarket accordingly. The server 106 may also communicate earlier with the service provider 104, e.g. for determining the estimated time for delivery.

It should be noted while the server 106 is described as a single server, its functionality, e.g. for providing a certain service and advertisement data will in practical application typically be provided by an arrangement (i.e. a server computer system) of multiple server computers (e.g. implementing a cloud service). Accordingly, the functionality described in the following provided by a server (e.g. server 106) may be understood to be provided by an arrangement of servers or server computers.

The communication arrangement 100 can be seen to realize an online to offline (O2O) marketplace (and thus as an O2O marketplace platform) since they exist online elements like the provision of online information by the server 106 for the smartphone to retrieve from the server 106 as well as offline elements like a driver delivering ordered food. In other words, there are online channels (specifically for transmitting information like for offering food an ordering) and offline channels (here for actual delivery of food).

According to various embodiments, approaches are provided to address fraud problem in such a O2O marketplace by considering correlations among different fraudsters operating in the marketplace (or on the platform) such as that a fraudulent user may both conduct promotion abuse as well as collude with a merchant (i.e. the user and the merchant are correlated fraudsters). The approaches can be applied to many different types of fraud activities, e.g., promotion abuse, unfunded cashless payment, customer-merchant collusion, etc, thus providing a sustainable framework for fraud detection in the O2O marketplace.

The server 106 may store information about interactions between parties, in this example transactions between users like the user of the smartphone 100 and service providers like the service provider 104 in the data storage 108 for analysis. For example, both food order and grocery transactions as well as e-hailing trips (which also can be seen to correspond to a transaction since the passenger pays for the trip) form interactions between customers and merchants (in general service providers including for example also drivers).

According to various embodiments, a graph is used to explicitly model the diverse types of user interactions in the O2O marketplace. Specifically, various embodiments include the following operations:
1. Identify and collect a variety of online and offline user interaction data in the O2O marketplace
2. Construct an O2O graph that explicitly models user interactions from both the online and offline channels in the O2O marketplace, e.g., two users are connected on the graph if they share the same device (online channel) or the same merchant (offline channel), etc.
3. Design graph node features based on graph structure information and domain knowledge. The graph structural information captures how the user is connected to other users, and the domain knowledge captures the integrity of the user himself/herself.
4. Enable automated fraud detection on the O2O graph with graph convolutional algorithms

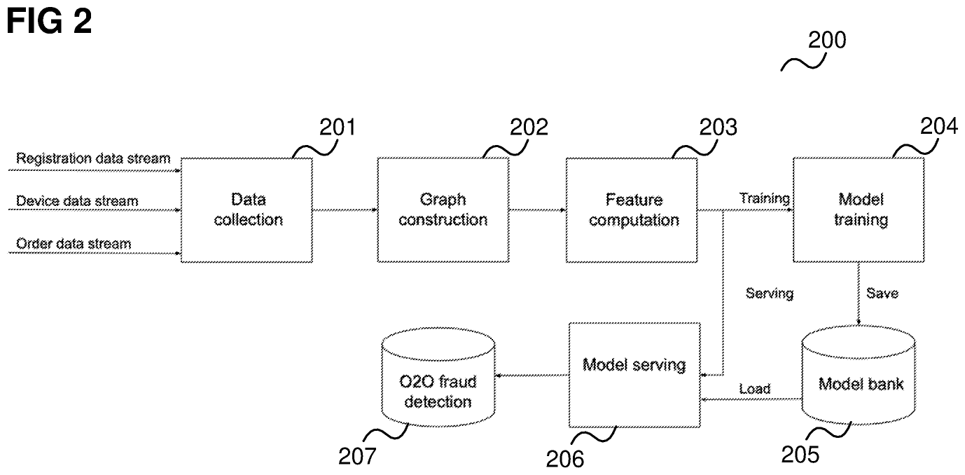

FIG. 2 shows a diagram 200 illustrating a data processing flow for fraud detection according to an embodiment, e.g. performed by the server 106.

The data processing flow includes data processing 201 from a registration data stream, a device data stream and an order data stream and the construction 202 of an O2O graph using the collected data.

Further, the data processing flow includes feature computation 203, wherein for each node of the graph features are computed using graph structure information and domain knowledge. The data processing flow further includes training 204 of a machine learning model (comprising a graph convolutional neural network) using the constructed graph (including the computed graph node features) and saving the trained model into a model storage (model bank) 205. It should be noted that the model may be trained or re-trained using further graphs created similarly.

The trained model may then be used for inference in a model serving stage 206. This includes loading the model parameters of the trained model (i.e. in particular neural network weights) from the model bank 205 and running inference on a graph created for a scenario for which fraud should be detected (similarly as the graph or graphs used for training the model). The model outputs model prediction scores which are used for fraud detection 207 in the O2O marketplace, e.g. a model prediction scores indicates a likelihood for an associated user (e.g. associated with a graph node with this the model prediction score is associated) that the user has performed fraud.

The components and data used in the data processing flow of FIG. 2 are described in more detail in the following. Table 1 describes the data collected in the data collection 201 upon certain events.

TABLE 1

| Event | Data collected |
|---|---|
| Registration | User ID, IP address |
| Order | User ID, Merchant ID, Driver ID, Dropoff |
| | location |
| Device | User ID, IP address, Device ID |

These data collected for registration events, order events and device events form the data collected from the registration data stream, the order data stream and the order data stream, respectively. So,
A data collection of the registration data stream is triggered when a new account is created on the platform, and the user ID and the IP address are collected.
A data collection of the order data stream is triggered when a new order is placed, and the user ID, merchant ID, driver ID, and dropoff location are collected.
A data collection of the device data stream is triggered when a user starts the app, and the user ID, IP address, and device ID are collected.

The collected data is used to construct an O2O graph.

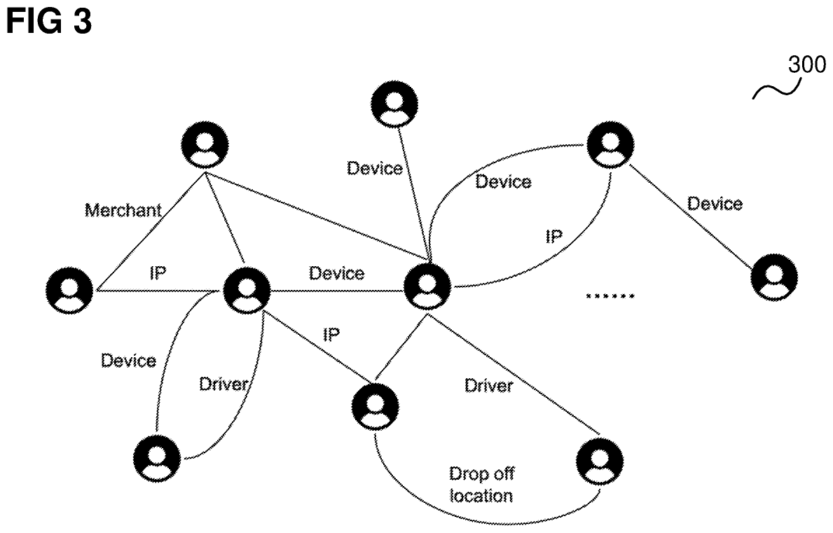

FIG. 3 shows an example for an O2O graph 300.

The graph's nodes correspond to users. The graph has an edge between to nodes if the users to which the nodes correspond have similarity of a certain type. For example, two nodes are connected if the corresponding users shared the same IP address or the same device (online channel) when registering and/or using the app (as known from the registration data stream and the device data stream). Users are also connected if they have ordered from the same merchant or have taken rides to the same location (offline channel; as known from the order data stream).

Table 2 gives examples of features calculated for the nodes of the graph in features computation 203.

TABLE 2

| | Feature name | Description |
|---|---|---|
| Graph | In/Out degree | The number of users that are |
| structure | | connected to the user of interest |
| features | Clustering coefficient | It measures how densely the |
| | | user is connected to its |
| | | neighbours (i.e. the density of |
| | | the cluster containing the node |
| | | corresponding to the user) |
| | Connected component | The number of users in a |
| | size | connected subgraph |
| Domain | Account age | Number of days since the user |
| knowledge | | account has been created |
| features | Number of orders | Number of orders from the user |
| | Promo ratio | The ratio of promo orders |
| | | among all the orders from the |
| | | user |
| | Average order value | The average value of an order |
| | | from the user |
| | Time since last login | The time elapsed since last login |
| | | activity from the user |
| | Time since last order | The time elapsed since last order |
| | | activity from the user |
| | Past profit | The total profit from the user in |
| | | the past |

The graph structure features of a node are determined from graph structure information and capture how the user corresponding to the node is connected to other users (i.e. how nodes corresponding to the users are connected in the graph), e.g., the density and size of the cluster on the graph. Fraudulent users are more likely to form dense clusters on the graph, because they need to reduce cost and sharing physical resources such as device, IP, location, etc. The clustering coefficient specifies the density of a cluster (which makes sense for a cluster with more than two nodes). For example, a cluster has four nodes (A, B, C, D) so the maximum number of connections are A-B, A-C, A-D, B-C, B-D, C-D. With all these connections, the cluster has maximum density (i.e. maximum clustering coefficient). When one or more of these connections are missing, e.g. only A-B, B-C, C-D are there, the cluster is less dense and thus its clustering coefficient is smaller.

The domain knowledge features of a node are determined from domain knowledge and capture the account integrity of the user corresponding to the node. Fraudulent users are more likely to be new accounts with less activity and zero or negative profit.

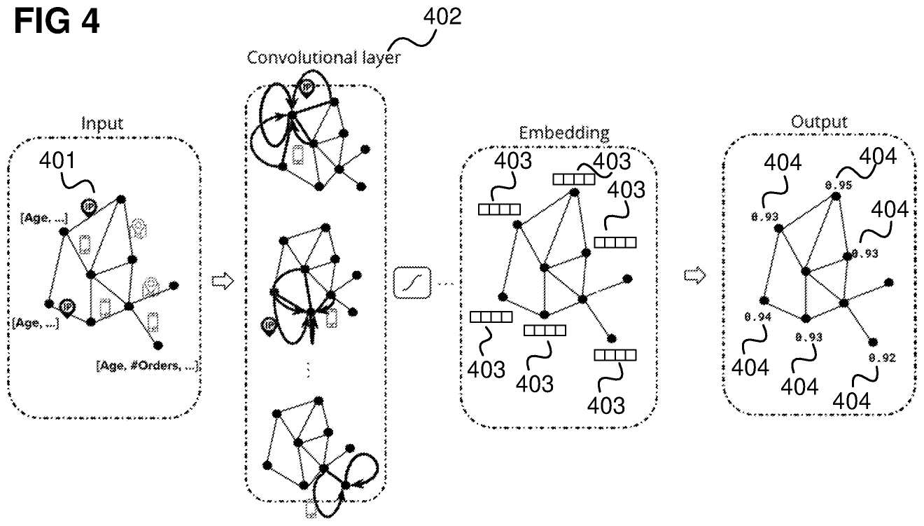

FIG. 4 illustrates the processing of an input graph 401 (corresponding to the constructed graph with the computed node features) by the machine learning model.

The input graph 401 is passed through several (graph) convolutional layers 402, where the features of each node are propagated to its neighbours to update the features of those neighbours, resulting, after the convolutional layers 402, in similar (updated) node features for nodes that are closely connected (i.e. which are directly connected or which are connected via a low number of intermediate nodes.

After that, an embedding 403 is computed for each node on the graph from the (updated) node features of the node. An example of a function to apply to the updated node features to calculate the node embedding is the rectified linear activation function (ReLU).

Finally, a fraud score 404 is computed for each node based on the node embeddings. An example of a function to apply to the node embedding to calculate the node score is the Softmax function.

The node score is for example a value in the interval [0, 1] which indicates a likelihood (or, in other words a prediction of the model for the likelihood) that the user corresponding to the user is a fraudulent user.

The model is trained in 204 with one or more constructed graphs which are partially labelled, i.e. for which some users (and thus nodes) are labelled as fraudulent or non-fraudulent. The model may then be trained in a semi-supervised manner (to achieve high node scores for nodes labelled as fraudulent. The one or more constructed graphs used for training may comprise a high number of nodes (e.g. 1.5 million nodes) and edges (e.g. 14 million edges), where only a small fraction (e.g. 4%) of the nodes are labelled as fraudulent or non-fraudulent (genuine). It should be noted that since the training is semi-supervised according to an embodiment, only a part of the nodes need labels in the training data. The trained model is then saved into the model storage 205.

In the model serving stage (i.e. inference), a graph is constructed from the most recent data of the data streams and inference is run on the graph with the trained model from the model storage 205. The predicted model scores are used for fraud detection purposes in the O2O marketplace. For example, the server 106 or its operator may react to a high value of a user, e.g. initiate investigations of the user for checking whether the user performs or has performed fraud, for example if the node score exceeds a predetermined threshold (or, equivalently, lies within a predetermined (“fraud indication”) range considered as being indicative of a fraudulent user) such as 0.8.

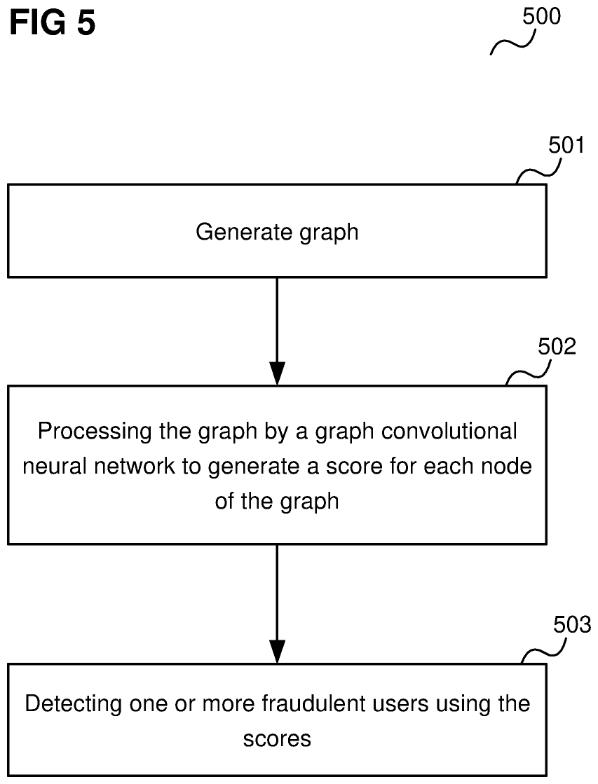

According to one embodiment, a method is provided as illustrated in FIG. 5.

FIG. 5 shows a flow diagram illustrating a method for detecting fraudulent users in a marketplace system.

In 501, a graph (in the sense of mathematical graph theory) is created, wherein users are represented as nodes of the graph and two nodes are connected by an edge if the user represented by one of the nodes has used at least one marketplace system element (e.g. in a predetermined set of market system element defined for the purpose of deciding whether two nodes should be connected by an edge) which was also used by the user represented by the other of the nodes in the marketplace system (e.g. if the user has performed at least one transaction in the marketplace system which used at least one marketplace system element which was also used by at least one transaction performed by the user represented by the other of the nodes in the marketplace system) and each node is associated with a feature set including information about behaviour of the user who is represented by the node in the marketplace system and structure information about a subgraph of the graph to which the node belongs.

In 502, the graph is processed by a graph convolutional neural network configured to generate a score for each node of the graph.

In 503, one or more fraudulent users are detected using the scores.

According to various embodiments, in other words, fraudulent users are detected by combining information about user behaviour (which may be indicative of fraudulent behaviour) between users which have certain relations in the marketplace system in the sense that they have used similar elements (in particular online and offline channels in an O2O marketplace system).

A graph convolutional neural network is used to generate scores (e.g. via embeddings which are generated from the features of the nodes by graph convolution operations, e.g. messages between nodes) and fraudulent users are detected based on the generated (i.e. calculated) scores.

The method may comprise training the graph convolutional neural network, e.g. using semi-supervised training using a training data set where fraudulent users are labelled. A training data set may for example be generated from historical data where fraudulent users have been detected by other means or experts may generate (possibly be simulation) a training data set, e.g. using certain fraud scenarios for fraudulent users.

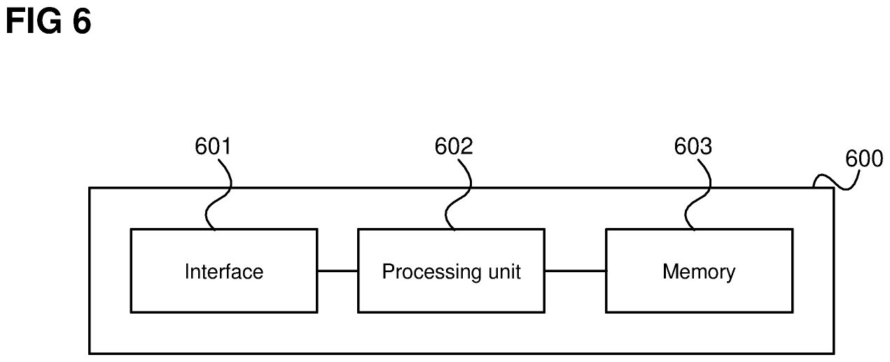

The method of FIG. 5 is for example carried out by a server computer system as illustrated in FIG. 6.

FIG. 6 shows a server computer system 600 according to an embodiment.

The server computer system 600 includes a communication interface 601 (e.g. configured to receive data regarding demand and supply. The server computer system 600 further includes a processing unit 602 and a memory 603. The memory 603 may be used by the processing unit 602 to store, for example, data to be processed, such as information about demand and supply. The server computer system is configured to perform the method of FIG. 5.

The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method for detecting fraudulent users in a marketplace system, comprising:
generating a graph, wherein users are represented as nodes of the graph and two nodes are connected by an edge if the user represented by one of the nodes has used at least one marketplace system element which was also used by the user represented by the other of the nodes in the marketplace system and each node is associated with a feature set including information about behaviour of the user who is represented by the node in the marketplace system and structure information about a subgraph of the graph to which the node belongs;
processing the graph by a graph convolutional neural network configured to generate a score for each node of the graph; and
detecting one or more fraudulent users using the scores.

2. The method of claim 1, wherein the structure information about the subgraph of the graph to which the node belongs includes information about how the node is connected to other nodes of the graph.

3. The method of claim 1, wherein the structure information about the subgraph of the graph to which the node belongs includes at least one of the quantity of other nodes connected to the node, information on how densely the node is connected to other nodes and the quantity of nodes of the subgraph, wherein the subgraph is the largest connected subgraph of the graph to which the node belongs.

4. The method of claim 1, wherein the information about the behaviour of the user includes information indicative of the integrity of the user.

5. The method of claim 1, wherein the marketplace system is an online to offline marketplace system.

6. The method of claim 5, wherein the marketplace system element is an online channel or an offline channel of the online to offline marketplace system.

7. The method of claim 1, wherein the marketplace system element is a user device, an Internet protocol address, a merchant, a driver or a vehicle.

8. The method of claim 1, wherein the graph convolutional neural network is configured to generate an embedding of each node and is configured to generate, for each node, the score for the node from the embedding of the node.

9. The method of claim 1, wherein the information about the behaviour of the user includes one or more of an age of an account the user has with the marketplace system, a number of orders issued by the user in the marketplace system, a ratio of promotion orders among the orders issued by the user in the marketplace system, an average order value of the user in the marketplace system, a time since the last login by the user in the marketplace system, a time since the last order by the user in the marketplace system, a total profit of the user in the marketplace system.

10. The method of claim 1, comprising detecting one or more fraudulent users using the scores by detecting a user as being a fraudulent user if the score of the node lies within a predetermined range.

11. The method of claim 1, comprising activating a security measure for a user if the user was detected as fraudulent user.

12. The method of claim 1, comprising training the graph convolutional neural network by semi-supervised training using a labelled training data set comprising labels indicating fraudulent users.

13. A server computer system for detecting fraudulent users in a marketplace system, comprising:
a radio interface;
a memory interface; and
a processing unit configured to: generate a graph, wherein users are represented as nodes of the graph and two nodes are connected by an edge if the user represented by one of the nodes has used at least one marketplace system element which was also used by the user represented by the other of the nodes in the marketplace system and each node is associated with a feature set including information about behaviour of the user who is represented by the node in the marketplace system and structure information about a subgraph of the graph to which the node belongs;
process the graph by a graph convolutional neural network configured to generate a score for each node of the graph; and
detect one or more fraudulent users using the scores.

14. (canceled)

15. A non-transitory computer-readable medium comprising program instructions, which, when executed by one or more processors, cause the one or more processors to perform a method for detecting fraudulent users in a marketplace system, comprising:
generating a graph, wherein users are represented as nodes of the graph and two nodes are connected by an edge if the user represented by one of the nodes has used at least one marketplace system element which was also used by the user represented by the other of the nodes in the marketplace system and each node is associated with a feature set including information about behaviour of the user who is represented by the node in the marketplace system and structure information about a subgraph of the graph to which the node belongs;
processing the graph by a graph convolutional neural network configured to generate a score for each node of the graph; and
detecting one or more fraudulent users using the scores.
